(19) United States
(12) Patent Application Publication
(10) Pub. No.: US 2016/0188151 A1
(43) Pub. Date: Jun. 30, 2016

(54) Information Processing Method And Electronic Device

(71) Applicant: Lenovo (Beijing) Co., Ltd., Beijing (CN)

(72) Inventor: Ben XU, Beijing (CN)

(73) Assignee: LENOVO (BEIJING) CO., LTD., Beijing (CN)

(21) Appl. No.: 14/711,081

(22) Filed: May 13, 2015

(30) Foreign Application Priority Data
Dec. 29, 2014 (CN) 201410848938.9

(51) Int. Cl. G06F 3/0488; G06F 3/044

(52) U.S. Cl. CPC G06F 3/0488; G06F 3/044

(57) ABSTRACT

An information processing method and an electronic device are provided. The information processing method is applied to an electronic device including a touch screen with a multi-touch function and a display unit. The information processing method includes: acquiring a touch operation in the case that a first display interface corresponding to a first content is displayed on the display unit; acquiring position information of the touch operation; and determining a first partial content in a graphic region as a first to-be-projected content according to the position information, where the first partial content is a part of the first content. With the information processing method, the projection region is quickly determined based on a requirement of a user.

### CROSS-REFERENCE TO RELATED APPLICATION

The present application claims the priority to Chinese Patent Application No. 201410848938.9, entitled “INFORMATION PROCESSING METHOD AND ELECTRONIC DEVICE”, filed on Dec. 29, 2014 with the State Intellectual Property Office of People's Republic of China, which is incorporated herein by reference in its entirety.

### FIELD

The present disclosure relates to the technical field of electronics, and in particular, to an information processing method and an electronic device.

### BACKGROUND

With development of science and technology, more and more electronic devices are multi-functional. To meet demands of a user for projection function, more and more electronic devices are provided projection units, for projecting contents currently displayed or other contents suitable for projection in the electronic devices.

In the conventional technology, when using the projection unit of the electronic device to project a certain content, the projection operation is generally performed based on personal preference of the user. That is to say, regional projection is performed for the certain content. For example, a policeman A receives a mail from an informer B, and the mail content is that “The drug cartel called ‘panther’ will make the drug trade at the Crown pier at 19:30 on the Halloween Day”. In this case, to protect personal information of the informer B and ensure personal safety of the informer B, the regional projection technique is adopted by the policeman A in the meeting. Specifically, the to-be-projected content is amplified firstly, and the to-be-projected content is dragged onto the projection screen, thereby projecting and displaying only the to-be-projected content, and protecting the informer while ensuring information authenticity.

In the conventional technology, during projecting partial content within an region by using the regional projection technique, a projection region with fixed size and fixed position needs to be preset generally, the partial to-be-projected content needs to be amplified, and the amplified partial to-be-projected content needs to be dragged onto the projection region, thereby displaying the partial content within the region. In the conventional technology, the process of the regional projection is complicated, and it is unavailable to quickly determine a suitable projection region for projection of the projection content in the projection region.

In the conventional regional projection technique, since the projection region has a fixed size and a fixed position, the electronic device cannot quickly adjust the size and position of the projection region based on the requirement of the user.

### SUMMARY

In embodiments of the disclosure, an information processing method and an electronic device are provided for solving the technical problems in the conventional technology that the process of the regional projection is complicated and a suitable projection region cannot be determined quickly to project a projection content in the projection region, thereby determing the projection region quickly based on the requirement of the user.

In one aspect of the disclosure, an information processing method is provided, the method is applicable to an electronic device including a touch screen with a multi-touch function and a display unit, and the method includes:

acquiring a touch operation in the case that a first display interface corresponding to a first content is displayed on the display unit;

acquiring position information of the touch operation; and

determining a first partial content in a graphic region as a first to-be-projected content according to the position information, where the first partial content is a part of the first content.

Optionally, the determining a first partial content in a graphic region as a first to-be-projected content according to the position information may include:

acquiring a graphic region conforming to a preset rule from the first display interface based on the position information; and

determining the first partial content in the graphic region as the first to-be-projected content.

Optionally, the acquiring a graphic region conforming to a preset rule from the first display interface based on the position information may include:

acquiring coordinates of a first touch point of the touch operation and coordinates of a second touch point of the touch operation; and

determining, according to the preset rule, a first circle region by taking a first straight line segment between the first touch point and the second touch point as a diameter of the first circle region.

Optionally, the acquiring a graphic region conforming to a preset rule from the first display interface based on the position information may include:

acquiring initial coordinates of a first touch point of the touch operation and initial coordinates of a second touch point of the touch operation; and

detecting whether the coordinates of the first touch point are changed and whether the coordinates of the second touch point are changed, and determining a second circle region as the graphic region by taking a second straight line segment between the initial coordinates of the first touch point and the initial coordinates of the second touch point as a diameter of the second circle region and taking a touch point of which the coordinates are unchanged as a center of the second circle region.

Optionally, the acquiring a graphic region conforming to a preset rule from the first display interface based on the position information may include:

acquiring coordinates of a starting point and coordinates of an ending point of a sliding of a first touch point and coordinates of a stating point and coordinates of an ending point of a sliding of a second touch point, in the case that the first touch point and the second touch point of the touch operation slide on the touch screen; and

determining a closed region as the graphic region, where the starting point and the ending point of the sliding of the first touch point and the starting point and the ending point of the sliding of the second touch point are located on the boundary of the closed region.

Optionally, the acquiring a graphic region conforming to a preset rule from the first display interface based on the position information may include:

acquiring at least three touch points; and

determining a closed region as the graphic region, where the at least three touch points are located on the boundary of the closed region.

In another aspect of the disclosure, an electronic device is provided, and the electronic device includes:

a touch screen;

a display unit;

a first acquiring unit, configured to acquire a touch operation in the case that a first display interface corresponding to a first content is displayed on the display unit;

a second acquiring unit, configured to acquire position information of the touch operation; and

a determining unit, configured to determine a first partial content in a graphic region as a first to-be-projected content according to the position information, where the first partial content is a part of the first content.

Optionally, the determining unit may include:

an acquiring sub-unit, configured to acquire a graphic region conforming to a preset rule from the first display interface based on the position information; and

a determining sub-unit, configured to determine the first partial content in the graphic region as the first to-be-projected content.

Optionally, the acquiring sub-unit may include:

a first acquiring module, configured to acquire coordinates of a first touch point of the touch operation and coordinates of a second touch point of the touch operation; and

a first processing module, configured to determine, according to the preset rule, a first circle region by taking a first straight line segment between the first touch point and the second touch point as a diameter.

Optionally, the acquiring sub-unit may include:

a second acquiring module, configured to acquire initial coordinates of a first touch point of the touch operation and initial coordinates of a second touch point of the touch operation; and

a second processing module, configured to, detect whether the coordinates of the first touch point are changed and whether the coordinates of the second touch point are changed, and determine a second circle region as the graphic region by taking a second straight line segment between the initial coordinates of the first touch point and the initial coordinates of the second touch point as a diameter of the second circle region and taking a touch point of which the coordinates are unchanged as a center of the second circle region.

Optionally, the acquiring sub-unit may include:

a third acquiring module, configured to acquire coordinates of a starting point and coordinates of an ending point of a sliding of a first touch point and coordinates of a stating point and coordinates of an ending point of a sliding of a second touch point, in the case that the first touch point and the second touch point of the touch operation slide on the touch screen; and

a third processing module, configured to determine a closed region as the graphic region, where the starting point and the ending point of the sliding of the first touch point and the starting point and the ending point of the sliding of the second touch point are located on the boundary of the closed region.

Optionally, the acquiring sub-unit may include:

a fourth acquiring module, configured to acquire at least three touch points; and

a fourth processing module, configured to determine a closed region as the graphic region, where the at least three touch points are located on the boundary of the closed region.

### BRIEF DESCRIPTION OF THE DRAWINGS

The appended drawings to be used in the description of embodiments or the conventional technology are described briefly as follows, so that the technical solutions according to the embodiments of the present disclosure or according to the conventional technology may become clearer. It is obvious that the appended drawings in the following description only illustrate some embodiments of the present disclosure.

FIG. 1 is a flowchart of an information processing method according to a first embodiment of the disclosure, and FIG. 2 illustrates detailed processes of step S103 in FIG. 1;

FIG. 3 is a flowchart of a first implementation of step S1031 of the information processing method according to the first embodiment of the disclosure;

FIG. 4 is a flowchart of a second implementation of step S1031 of the information processing method according to the first embodiment of the disclosure;

FIG. 5 is a flowchart of a third implementation of step S1031 of the information processing method according to the first embodiment of the disclosure;

FIG. 6 is a flowchart of a fourth implementation of step S1031 of the information processing method according to the first embodiment of the disclosure;

FIG. 7 is a block diagram showing a functional structure of an electronic device according to a second embodiment of the disclosure.

### DETAILED DESCRIPTION OF THE EMBODIMENTS

An information processing method and an electronic device are provided according to embodiments of the disclosure, for solving the technical problems in the conventional technology that the process of the regional projection is complicated and a suitable projection region cannot be determined quickly to project a projection content in the projection region. With the information processing method and the electronic device, the projection region is quickly determined based on a requirement of a user.

Technical solutions in the embodiments of the disclosure may solve the above technical problems based on the following general concepts.

An information processing method is provided, which is applicable to an electronic device, where the electronic device includes a touch screen with a multi-touch function and a display unit.

The information processing method includes:

acquiring a touch operation in the case that a first display interface corresponding to a first content is displayed on the display unit;

acquiring position information of the touch operation; and

determining a first partial content in a graphic region as a first to-be-projected content according to the position information, where the first partial content is a part of the first content.

The determining a first partial content in a graphic region as a first to-be-projected content according to the position information may include:

acquiring a graphic region conforming to a preset rule from the first display interface, based on the position information; and

determining the first partial content in the graphic region as the first to-be-projected content.

In the technical solutions in the embodiments of the disclosure, based on the position information of the touch operation acquired by detection, the graphic region conforming to the preset rule is acquired from a display interface of the display unit of the electronic device, the acquired graphic region is a projection region, and the content within the graphic region is a to-be-projected content. Thus, the projection region can be determined quickly based on the requirement of the user.

The technical solutions in the disclosure are described in detail in conjunction with the drawings and embodiments hereinafter, so that the above technical solutions become clearer. It should be understood that the embodiments of the disclosure and the specific features in the embodiments are to illustrate the technical solutions of the disclosure in detail, but not to limit the technical solutions of the disclosure, and the embodiments of the disclosure and the specific features in the embodiments can be combined if no confliction may be caused by the combination.

### A First Embodiment

An information processing method is provided according to the embodiment. The information processing method is applicable to an electronic device, where the electronic device includes a touch screen with a multi-touch function and a display unit. The method includes following steps S101 to S103.

In step S101, a touch operation is acquired in the case that a first display interface corresponding to a first content is displayed on the display unit.

In step S102, position information of the touch operation is acquired.

In step S103, a first partial content in a graphic region is determined as a first to-be-projected content according to the position information, where the first partial content is a part of the first content.

Step S103 may include steps S1031 and S1032. In step 1031, a graphic region conforming to a preset rule is acquired from the first display interface based on the position information; and in step S1032, the first partial content in the graphic region is determined as the first to-be-projected content.

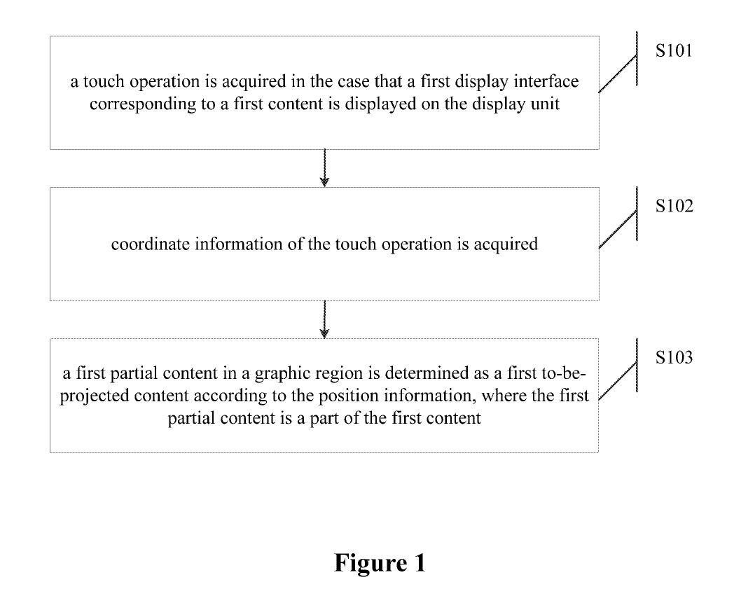

Reference is made to FIG. 1, which is a flowchart of an information processing method according to the first embodiment of the disclosure. In practice, the electronic device may be a cell phone or a tablet computer including a touch screen, a display unit and a projection unit, or may be other electronic devices which are not listed one by one here. Touch screens may be classified into different types based on different touch detection techniques. For example, the touch screen may be a resistive touch screen, a capacitive touch screen, an infrared touch screen, or a surface acoustic wave touch screen. Although the touch screens may be of different types, coordinates of a touch point on the touch screen can be acquired upon detecting the touch operation performed by the user on any type of touch screen.

Hereinafter, implementations of the embodiment of the disclosure are explained based on an example that the electronic device is a cell phone.

In an embodiment of the disclosure, different gesture detections are provided for different gestures. For example, for an Andriod device, there are two kinds of gestures as follows. One kind of gestures is a slide of a finger of the user performed on the screen, and this kind of gestures are detected by a monitor provided in the Andriod device. Another kind of gestures is sliding, by the finger of the user, on the screen to obtain a certain irregular geometry (i.e., to obtain a geometry with a certain shape on the screen by multiple continuous time periods of touch). Practically, there exist other implementations of gestures. Different preset rules are provided for different implementations of gestures in the electronic device. Due to different preset rules, different projection regions are determined based on the position information of the touch operation and the preset rules. Thus, step S1031 of acquiring a graphic region conforming to a preset rule from the first display interface based on the position information may have, but not limited to, following four implementations.

A First Implementation

The first implementation is for a first preset rule. Reference is made to FIG. 2, where step S1031 includes following steps S201 and S202.

In step S201, coordinates of a first touch point of the touch operation and coordinates of a second touch point of the touch operation are acquired.

In step S202, a first circle region is determined, according to the preset rule, by taking a first straight line segment between the first touch point and the second touch point as a diameter of the first circle region.

In practice, in the case that the user performs a two-point touch operation on the touch screen of the cell phone, the first preset rule is that the two-point touch operation is performed on the touch screen of the cell phone directly and statically. According to the first preset rule, in the case that the projection unit inside the cell phone is in an enabled state and a first interface containing a first content is displayed on the display unit of the cell phone, the touch screen captures the position information of the touch points, and the touch screen of the cell phone detects to acquire the coordinates of the first touch point of the touch operation and the coordinates of the second touch point of the touch operation. Based on the coordinates of the first touch point, the coordinates of the second touch point, and the first preset rule, the first circle region is determined as a projection region, where the first straight line segment between the first touch point and the second touch point is a diameter of the first circle region.

Specifically, in the case that the user performs a two-point touch operation on the screen of the cell phone, the first touch point and the second touch point are directly located on the touch screen, and it is detected that neither of the coordinates of the first touch point nor the coordinates of the second touch point changes. That is to say, the first touch point and the second touch point are static. In this case, the first preset rule is to determine a circle region taking the first straight line segment between the first touch point and the second touch point as the diameter of the circle region. For example, in a rectangular plane coordinate system where a surface of the touch screen is located, the touch screen detects that coordinates of the centre of the first touch point are (1, 1) and coordinates of the centre of the second touch point are (4, 5), and accordingly, the length of the first straight line segment between the centres of the two touch points is 5. According to the first preset rule, the circle region, which is determined by taking the first straight line segment as the diameter of the circle region, is acquired as the projection region. In addition, in the case of a single-point touch operation, if the only one touch point moves continuously on the touch screen, coordinates of an initial point of the movement of the touch point and coordinates of a final point of the movement of the touch point may be acquired, and a circular region is determined by taking a straight line segment between the initial point and the final point as the diameter of the circular region.

In the first implementation, if the coordinates of the touch points are changed, for example, if the first touch point and the second touch point of the two-point touch operation are located at positions with coordinates different from the coordinates described above, new position information is acquired, and a projection region different from the first circular region described above is determined based on the new position information.

A Second Implementation

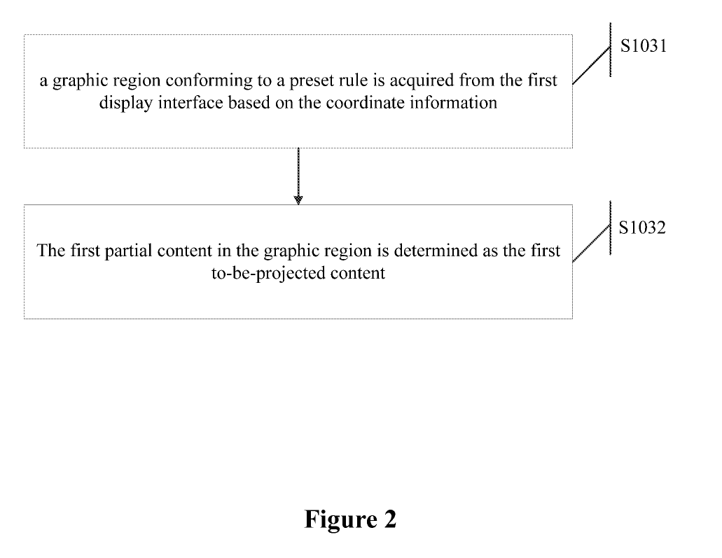

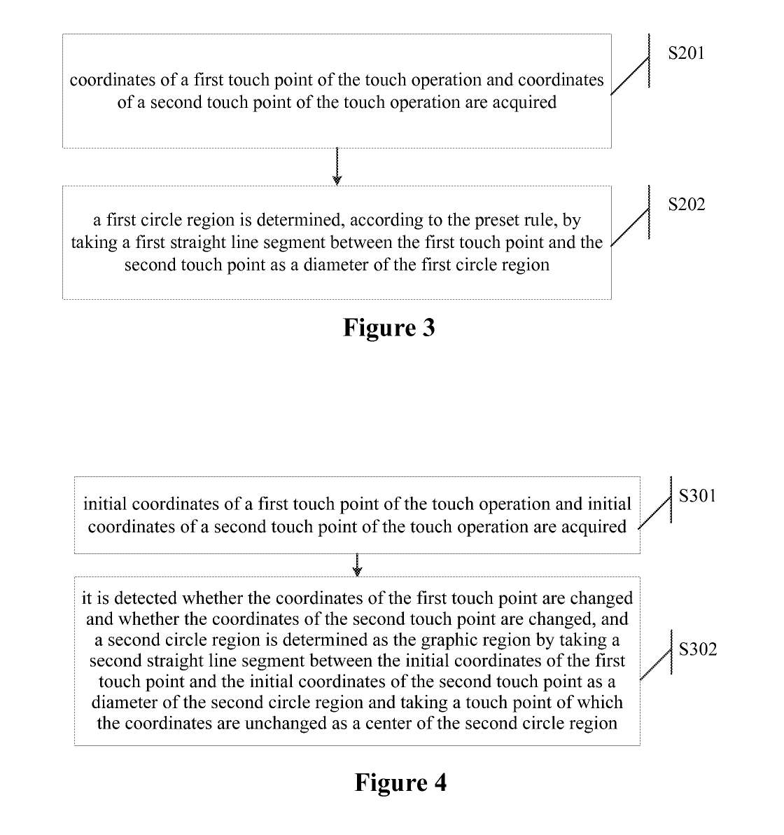

The second implementation is for a first preset rule. Reference is made to FIG. 3, where step S1031 includes following steps S301 and S302.

In step S301, initial coordinates of a first touch point of the touch operation and initial coordinates of a second touch point of the touch operation are acquired.

In step S302, it is detected whether the coordinates of the first touch point are changed and whether the coordinates of the second touch point are changed, and a second circle region is determined as the graphic region by taking a second straight line segment between the initial coordinates of the first touch point and the initial coordinates of the second touch point as a diameter of the second circle region and taking a touch point of which the coordinates are unchanged as a center of the second circle region.

Specifically, in the case that the user performs a two-point touch operation on the screen of the cell phone, it is detected whether the coordinates of the first touch point are changed and whether the coordinates of the second touch point are changed. If the second touch point of the two-point touch operation is static and the first touch point slides around the second touch point, a projection region may be determined based on a sliding tendency of the first touch point, that is to say, the projection region is determined according to the second preset rule. That is to say, the second circle region is determined by taking a second straight line segment between the initial coordinates of the first touch point and the initial coordinates of the second touch point as a diameter of the second circle region and taking a touch point of which the coordinates are unchanged as a center of the second circle region. Firstly, the touch screen of the cell phone captures initial coordinates of the first touch point and initial coordinates of the second touch point of the two-point touch operation. Then, it is detected whether the coordinates of the first touch point are changed and whether the coordinates of the second touch point are changed. In the case that the coordinates of the second touch point are detected as unchanged and the coordinates of the first touch point are detected as changed, for example, if it is detected that, on the touch screen, the first touch point rotates around the second touch point which is static, a second circle region is determined, based on the initial coordinates of the first touch point, the initial coordinates of the second touch point and the second preset rule, as the projection region by taking the second touch point as the center of the second circle region and taking the second straight line segment between initial coordinates of the first touch point and initial coordinates of the second touch point as the diameter of the second circle region. In an alternative case of the disclosure, the coordinates of the first touch point are unchanged and the coordinates of the second touch point are changed. For example, the first touch point is static, and the second touch point rotates around the first touch point. That is to say, a second circle region is determined as the projection region by taking the first touch point as the center of the second circle region and taking the second straight line segment between the initial coordinates of the first touch point and the initial coordinates of the second touch point as the diameter of the second circle region.

Based on other sliding trends of gesture of the user, graphic regions with different shapes may be determined. For example, in the case of the single-point touch operation, if an arc track is formed on the screen by multiple continuous time periods of touch, it is considered that the user wants to select a circle region as the projection region. In this case, the preset rule may be that the circle region is determined by taking the starting point and the ending point of the sliding track as two boundary points of the circle region. For other sliding traces, descriptions are not given here one by one.

In the second implementation, if the coordinates of the touch points are changed, for example, if the first touch point and the second touch point of the two-point touch operation are located at points with coordinates different from the coordinates described above, new position information is acquired, and a projection region different from the second circular region described above is determined based on the new position information.

A Third Implementation

The third implementation is for a third preset rule. |Reference is made to FIG. 4, where step S1031 includes following steps S401 and S402.

In step S401, coordinates of a starting point and coordinates of an ending point of a sliding of a first touch point, and coordinates of a stating point and coordinates of an ending point of a sliding of a second touch point are acquired, in the case that the first touch point and the second touch point of the touch operation both slide on the touch screen.

In step S402, a closed region is determined as the graphic region, where the starting point and the ending point of the sliding of the first touch point and the starting point and the ending point of the sliding of second touch point are located on the boundary of the closed region.

Specifically, in the case that the user performs a two-point touch operation on the screen of the cell phone, if the first touch point and the second touch point slide on the touch screen of the cell phone, coordinates of the starting point and coordinates of the ending point of the sliding of the first touch point and coordinates of the stating point and coordinates of the ending point of the sliding of the second touch point are acquired according to the third preset rule set in the cell phone. A closed region is determined as the graphic region, where the starting point and the ending point of the sliding of the first touch point and the starting point and the ending point of the sliding of second touch point are located on the boundary of the closed region.

Specifically, in the case that the user performs a two-point touch operation on the screen of the cell phone, for example, a sliding track of the first touch point is a, and a sliding track of the second touch point is b. The position of a starting point and of the position of an ending point of the sliding track a are respectively c and d; the position of a starting point and the position of an ending point of the sliding track b are respectively e and f, and c, d, e and f are located on the boundary of a closed region determined as the projection region.

In the third implementation, if the coordinates of the touch points are changed, for example, if the first touch point and the second touch point of the two-point touch operation are relocated at a position different from the above-mentioned starting point of the sliding of the first touch point and a position different from the above-mentioned starting point of the sliding of the second touch point, and then the first touch point and the second touch point of the touch operation slide on the touch screen, new position information of starting points and ending points of slidings of the first touch point and the second touch point are acquired, and a graphic region different from the above is determined based on the new position information.

A Fourth Implementation

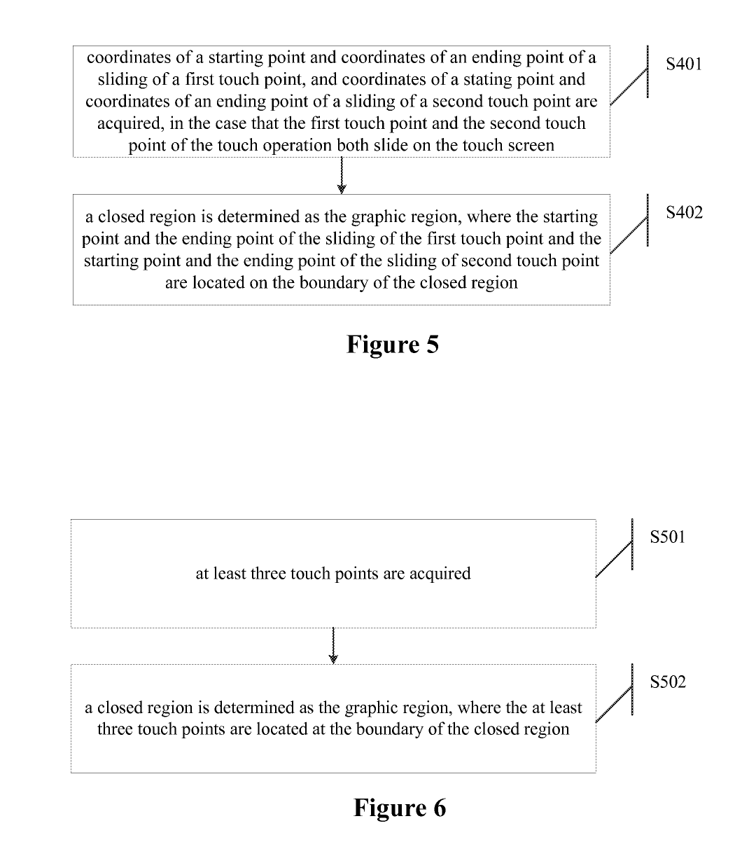

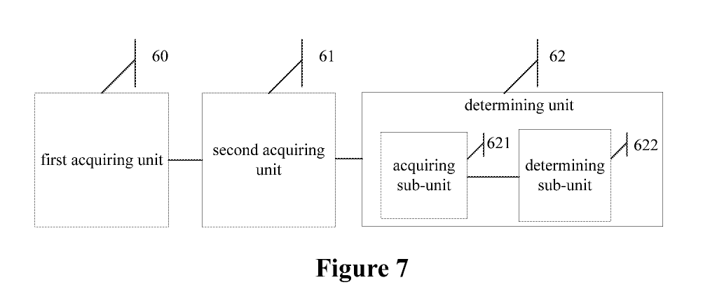

The fourth implementation is for a fourth preset rule. Reference is made to FIG. 5, where step S1031 includes following steps S501 and S502.

In step S501, at least three touch points are acquired.

In step S502, a closed region is determined as the graphic region, where the at least three touch points are located at the boundary of the closed region.

Specifically, in the case that the user performs a multi-touch operation on the screen of the cell phone, for example, in the case that user touches the touch screen of the cell phone with five fingers of his or her right hand to perform a five-point touch operation, the fourth preset rule is that the multi-touch operation is static with respect to the touch screen of the cell phone. According to the fourth preset rule, a closed region is determined as the projection region based on position information of the respective touch points.

Specifically, in the case that the user performs a five-point touch operation on the screen of the cell phone, it is detected that the position of the thumb is a point C, the position of the index finger is a point D, the position of the middle finger is a point E, the position of the ring finger is a point F, and the position of the little finger is a point G. A closed region is determined as the projection region, where the points C, D, E, F and G are located on the boundary of the closed region. Practically, in an embodiment of the disclosure, the touch operation may be other kind of multi-touch operations, which are not described here one by one.

In the fourth implementation, if the coordinates of the touch points are changed, for example, if the touch points of the five-point touch operation are relocated at points different from the above points, for example, if the thumb is located at a point H different from the point C, a closed region is determined according to the fourth preset rule, where the points D, E, F, G and H are located on the boundary of the closed region and the closed region is different from the previous closed region determined based on points C, D, E, F and G.

In the embodiment of the disclosure, for any of the implementations, the graphic region generated according to the preset rule varies as the position information of the touch points changes. That is, the size and position of the projection region may be changed by adjusting the position information of the touch points based on the requirement of the user.

In the embodiment of the disclosure, after the graphic region conforming to the preset rule is acquired from the first display interface based on the position information in step S1031, the method proceeds to step S104 of determining the first partial content in the graphic region as a first to-be-projected content, where the first partial content is a part of the first content. In practice, in the case that the user performs a touch operation on the touch screen of the cell phone, the touch screen sends the acquired position information of the touch point(s) to a system-side controller, and the system-side controller determines the projection region according to the preset rule and controls the projection unit in the device to project the to-be-projected content in the projection region.

### A Second Embodiment

Based on the conception of the information processing method in the first embodiment of the disclosure, an electronic device is provided according to the second embodiment of the disclosure. As shown in FIG. 6, the electronic device includes a touch screen, a display unit, a first acquiring unit 60, a second acquiring unit 61 and a determining unit 62.

The first acquiring unit 60 is configured to acquire a touch operation in the case that a first display interface corresponding to a first content is displayed on the display unit.

The second acquiring unit 61 is configured to acquire position information of the touch operation.

The determining unit 62 is configured to determine a first partial content in a graphic region as a first to-be-projected content according to the position information, where the first partial content is a part of the first content.

The determining unit 62 includes an acquiring sub-unit 621 and a determining sub-unit 622. The acquiring sub-unit 621 is configured to acquire a graphic region conforming to a preset rule from the first display interface, based on the position information. The determining sub-unit 622 is configured to determine the first partial content in the graphic region as the first to-be-projected content.

To determine the projection region based on the requirement of the user, in the case that the preset rule is a first preset rule, the acquiring sub-unit includes a first acquiring module and a first processing module.

The first acquiring module is configured to acquire coordinates of a first touch point of the touch operation and coordinates of a second touch point of the touch operation.

The first processing module is configured to determine, according to the preset rule, a first circle region by taking a first straight line segment between the first touch point and the second touch point as a diameter.

To determine the projection region based on the requirement of the user, in the case that the preset rule is a second preset rule, the acquiring sub-unit includes a second acquiring module and a second processing module.

The second acquiring module is configured to acquire initial coordinates of a first touch point of the touch operation and initial coordinates of a second touch point of the touch operation.

The second processing module is configured to, detect whether the coordinates of the first touch point are changed and whether the coordinates of the second touch point are changed, and determine a second circle region as the graphic region by taking a second straight line segment between the initial coordinates of the first touch point and the initial coordinates of the second touch point as a diameter of the second circle region and taking a touch point of which the coordinates are unchanged as a center of the second circle region.

To determine the projection region based on the requirement of the user, in the case that the preset rule is a third preset rule, the acquiring sub-unit includes a third acquiring module and a third processing module.

The third acquiring module is configured to acquire coordinates of a starting point and coordinates of an ending point of a sliding of a first touch point and coordinates of a stating point and coordinates of an ending point of a sliding of a second touch point, in the case that the first touch point and the second touch point of the touch operation slide on the touch screen.

The third processing module is configured to determine a closed region as the graphic region, where the starting point and the ending point of the sliding of the first touch point and the starting point and the ending point of the sliding of the second touch point are located on the boundary of the closed region.

To determine the projection region based on the requirement of the user, in the case that the preset rule is a fourth preset rule, the acquiring sub-unit includes a fourth acquiring module and a fourth processing module.

The fourth acquiring module is configured to acquire at least three touch points.

The fourth processing module is configured to determine a closed region as the graphic region, where the at least three touch points are located on the boundary of the closed region.

In the technical solutions in the embodiments of the disclosure, based on the position information of the touch operation acquired by detection, the graphic region conforming to the preset rule is acquired from the display interface of the display unit of the electronic device, the acquired graphic region is the projection region, and the content within the graphic region is the to-be-projected content. Thus, the projection region can be determined quickly based on the requirement of the user.

Further, since the projection region conforming to the preset rule is determined based on the position information of the touch operation acquired by detection, the projection region varies as the position information varies; hence, the projection region can be moved and adjusted quickly by adjusting the position information.

It should be understood by those skilled in the art that the embodiments of the disclosure may be provided as a method, a system or a computer program product. Therefore, the embodiments of the disclosure may be completely hardware-based, completely software-based or software-hardware combined. Furthermore, the embodiments of the disclosure may be in the form of a computer program product implemented on one or more computer-available storage medium (which includes but is not limited to a disc storage, a CD-ROM, an optical storage) having computer available program codes.

The disclosure is described in conjunction with flowcharts and/or block diagrams of the method, device (system) and computer program product according to the embodiments of the disclosure. It is to be understood that each or any combination of flows and/or blocks in the flowcharts and/or block diagrams may be implemented with computer program instructions. The computer program instructions may be supplied to a processor of general-purpose computer, a dedicated computer, an embedded processor or other programmable data processing devices to generate a machine, so that apparatus(es) for implementing function(s) specified in one or multiple flows in the flowcharts and/or one or multiple blocks in the block diagrams may be generated with the instructions executed by the processor of computer or other programmable data processing devices.

Alternatively, the computer program instructions may be stored in a computer readable storage which can instruct the computer or other programmable data processing devices to function in specific ways so that a product including an instruction apparatus is generated with the instructions stored in the computer readable storage. The function(s) specified in one or multiple flows in the flowcharts and/or one or multiple blocks in the block diagrams may be implemented with the instruction apparatus.

Alternatively, the computer program instructions may be loaded to the computer or other programmable data processing devices, so that a series of operation steps are performed on the computer or other programmable devices to generate computer-implemented processes. Step(s) for implementing the function(s) specified in one or multiple flows in the flowcharts and/or one or multiple blocks in the block diagrams is provided with the instructions executed on the computer or other programmable devices.

Specifically, the computer program instructions corresponding to the information processing method in the embodiment of the disclosure may be stored in store medium such as an optic disk, a hard disk or a U disk. The computer program instructions corresponding to the information processing method and stored in the storage medium, when being executed by a processor, cause the processor to perform the following steps:

acquiring a touch operation in the case that a first display interface corresponding to a first content is displayed on the display unit;

acquiring position information of the touch operation; and

determining a first partial content in a graphic region as a first to-be-projected content according to the position information, where the first partial content is a part of the first content.

Optionally, the computer program instructions corresponding to the process of determining a first partial content in a graphic region as a first to-be-projected content according to the position information and stored in the storage medium, when being executed by the processor, cause the processor to perform the following steps:

acquiring a graphic region conforming to a preset rule from the first display interface based on the position information; and

determining the first partial content in the graphic region as the first to-be-projected content.

Optionally, the computer program instructions corresponding to the process of acquiring a graphic region conforming to a preset rule from the first display interface based on the position information and stored in the storage medium, when being executed by the processor, cause the processor to perform the following steps:

acquiring coordinates of a first touch point of the touch operation and coordinates of a second touch point of the touch operation; and

determining, according to the preset rule, a first circle region by taking a first straight line segment between the first touch point and the second touch point as a diameter of the first circle region.

Optionally, the computer program instructions corresponding to the process of acquiring a graphic region conforming to a preset rule from the first display interface based on the position information and stored in the storage medium, when being executed by the processor, cause the processor to perform the following steps:

acquiring initial coordinates of a first touch point of the touch operation and initial coordinates of a second touch point of the touch operation; and

detecting whether the coordinates of the first touch point are changed and whether the coordinates of the second touch point are changed, and determining a second circle region as the graphic region by taking a second straight line segment between the initial coordinates of the first touch point and the initial coordinates of the second touch point as a diameter of the second circle region and taking a touch point of which the coordinates are unchanged as a center of the second circle region.

Optionally, the computer program instructions corresponding to the process of acquiring a graphic region conforming to a preset rule from the first display interface based on the position information and stored in the storage medium, when being executed by the processor, cause the processor to perform the following steps:

acquiring coordinates of a starting point and coordinates of an ending point of a sliding of a first touch point and coordinates of a stating point and coordinates of an ending point of a sliding of a second touch point, in the case that the first touch point and the second touch point of the touch operation slide on the touch screen; and

determining a closed region as the graphic region, where the starting point and the ending point of the sliding of the first touch point and the starting point and the ending point of the sliding of the second touch point are located on the boundary of the closed region.

Optionally, the computer program instructions corresponding to the process of acquiring a graphic region conforming to a preset rule from the first display interface based on the position information and stored in the storage medium, when being executed by the processor, cause the processor to perform the following steps:

acquiring at least three touch points; and

determining a closed region as the graphic region, where the at least three touch points are located on the boundary of the closed region.

Preferred embodiments of the disclosure have been described, while alterations and modifications may be made to the embodiments by those skilled in the art based on basic creative concepts of the disclosure. Therefore, appended claims are intended to include the preferred embodiments and all the alterations and modifications falling within the scope of protection of the disclosure.

Apparently, various modifications and variations may be made by those skilled in the art without deviating from the spirit and scope of the disclosure. Therefore, if the modifications and variations fall within the scope of the claims and equivalent techniques of the disclosure, the disclosure is intended to include the modifications and variations.

1. An information processing method, which is applied to an electronic device comprising a touch screen with a multi-touch function and a display unit, wherein the method comprises:
acquiring a touch operation in the case that a first display interface corresponding to a first content is displayed on the display unit;
acquiring position information of the touch operation; and
determining a first partial content in a graphic region as a first to-be-projected content according to the position information, wherein the first partial content is a part of the first content.

2. The information processing method according to claim 1, wherein the determining a first partial content in a graphic region as a first to-be-projected content according to the position information comprises:
acquiring a graphic region conforming to a preset rule from the first display interface, based on the position information; and
determining the first partial content in the graphic region as the first to-be-projected content.

3. The information processing method according to claim 2, wherein the acquiring a graphic region conforming to a preset rule from the first display interface based on the position information comprises:
acquiring coordinates of a first touch point of the touch operation and coordinates of a second touch point of the touch operation; and
determining, according to the preset rule, a first circle region by taking a first straight line segment between the first touch point and the second touch point as a diameter of the first circle region.

4. The information processing method according to claim 2, wherein the acquiring a graphic region conforming to a preset rule from the first display interface based on the position information comprises:
acquiring initial coordinates of a first touch point of the touch operation and initial coordinates of a second touch point of the touch operation; and
detecting whether the coordinates of the first touch point are changed and whether the coordinates of the second touch point are changed, and determining a second circle region as the graphic region by taking a second straight line segment between the initial coordinates of the first touch point and the initial coordinates of the second touch point as a diameter of the second circle region and taking a touch point of which the coordinates are unchanged as a center of the second circle region.

5. The information processing method according to claim 2, wherein the acquiring a graphic region conforming to a preset rule from the first display interface based on the position information comprises:
acquiring coordinates of a starting point and coordinates of an ending point of a sliding of a first touch point and coordinates of a stating point and coordinates of an ending point of a sliding of a second touch point, in the case that the first touch point and the second touch point of the touch operation slide on the touch screen; and
determining a closed region as the graphic region, wherein the starting point and the ending point of the sliding of the first touch point and the starting point and the ending point of the sliding of the second touch point are located on the boundary of the closed region.

6. The information processing method according to claim 2, wherein the acquiring a graphic region conforming to a preset rule from the first display interface based on the position information comprises:
acquiring at least three touch points; and
determining a closed region as the graphic region, wherein the at least three touch points are located on the boundary of the closed region.

7. An electronic device, comprising:
a touch screen;
a display unit;
a first acquiring unit, configured to acquire a touch operation in the case that a first display interface corresponding to a first content is displayed on the display unit;
a second acquiring unit, configured to acquire position information of the touch operation; and
a determining unit, configured to determine a first partial content in a graphic region as a first to-be-projected content according to the position information, wherein the first partial content is a part of the first content.

8. The electronic device according to claim 7, wherein the determining unit comprises:
an acquiring sub-unit, configured to acquire a graphic region conforming to a preset rule from the first display interface based on the position information; and
a determining sub-unit, configured to determine the first partial content in the graphic region as the first to-be-projected content.

9. The electronic device according to claim 8, wherein the acquiring sub-unit comprises:
a first acquiring module, configured to acquire coordinates of a first touch point of the touch operation and coordinates of a second touch point of the touch operation; and
a first processing module, configured to determine, according to the preset rule, a first circle region by taking a first straight line segment between the first touch point and the second touch point as a diameter.

10. The electronic device according to claim 8, wherein the acquiring sub-unit comprises:
a second acquiring module, configured to acquire initial coordinates of a first touch point of the touch operation and initial coordinates of a second touch point of the touch operation; and
a second processing module, configured to, detect whether the coordinates of the first touch point are changed and whether the coordinates of the second touch point are changed, and determine a second circle region as the graphic region by taking a second straight line segment between the initial coordinates of the first touch point and the initial coordinates of the second touch point as a diameter of the second circle region and taking a touch point of which the coordinates are unchanged as a center of the second circle region.

11. The electronic device according to claim 8, wherein the acquiring sub-unit comprises:
a third acquiring module, configured to acquire coordinates of a starting point and coordinates of an ending point of a sliding of a first touch point and coordinates of a stating point and coordinates of an ending point of a sliding of a second touch point, in the case that the first touch point and the second touch point of the touch operation slide on the touch screen; and
a third processing module, configured to determine a closed region as the graphic region, wherein the starting point and the ending point of the sliding of the first touch point and the starting point and the ending point of the sliding of the second touch point are located on the boundary of the closed region.

12. The electronic device according to claim 8, wherein the acquiring sub-unit comprises:
a fourth acquiring module, configured to acquire at least three touch points; and
a fourth processing module, configured to determine a closed region as the graphic region, wherein the at least three touch points are located on the boundary of the closed region.
